(19) United States
(12) Patent Application Publication
(10) Pub. No.: US 2009/0323185 A1
(43) Pub. Date: Dec. 31, 2009

(54) POLARIZER, METHOD FOR PRODUCTION THEREOF, POLARIZING PLATE, OPTICAL FILM, AND IMAGE DISPLAY

(75) Inventors: Shusaku Goto, Ibaraki-shi (JP); Tsutomu Hani, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 12/486,866

(22) Filed: Jun. 18, 2009

(30) Foreign Application Priority Data
Jun. 30, 2008 (JP) 2008-171267
Mar. 27, 2009 (JP) 2009-079705

(51) Int. Cl. G02B 1/08; B29D 11/00

(52) U.S. Cl. 359/500; 264/1.34

(57) ABSTRACT

A polarizer of the present invention comprises stretched film that is obtained from a film by subjecting the film to at least a dyeing treatment with a dichroic material and a stretching treatment, wherein the film is made from a mixture containing a polyvinyl alcohol-based resin and a polycarboxylic acid compound having two or more carboxyl groups and/or one or more acid anhydride groups and a molecular weight of 1,000 or less. The polarizer can suppress degradation in optical properties to a minimum even at high temperature.

### BACKGROUND OF THE INVENTION

1. Field of the Invention

The present invention relates to a polarizer and a method for production thereof. The present invention also relates to a polarizing plate using the polarizer. The polarizer or the polarizing plate may be used alone or in the form of a laminated optical film to form an image display such as a liquid crystal display (LCD), an organic electro-luminescent (EL) display, a cathode ray tube (CRT), or a plasma display panel (PDP).

2. Description of the Related Art

The liquid crystal display market has rapidly expanded in such fields as clocks, mobile phones, PDAs, note PCs, PC monitors, DVD players, and TVs. Liquid crystal displays use liquid crystal switching to visualize changes in polarization state, and based on the display principle, they use polarizers. Particularly in TV applications and the like, there is an increasing demand for higher brightness, higher contrast, and wider viewing angle. Thus, higher transmittance, higher degree of polarization and higher color reproducibility are also demanded of polarizing plates.

Polarizers are conventionally produced by orienting a dichroic material such as dichroic iodine or a dichroic dye in a polyvinyl alcohol-based film. Specifically, polarizers are produced by subjecting a polyvinyl alcohol-based film being fed from a raw material roll to swelling treatment, dyeing treatment, crosslinking treatment, stretching treatment, washing treatment with water, drying treatment, and so on (JP-A No. 2004-341515). Such a polarizer is generally used in a polarizing plate, which includes the polarizer and a transparent protective film bonded to one or both sides of the polarizer with an adhesive interposed therebetween.

However, conventional polarizing plates have a problem in which when used in liquid crystal displays, they can be degraded in polarizing properties due to heat or humidity so that they can cause uneven display. In recent years, liquid crystal displays have been widely used and found a number of applications for long-term use under high-temperature or high-humidity conditions or the like, liquid crystal displays are required to have low hue change according to the applications to be used. For such applications, polarizing plates are also required to have durability at such a level that optical properties are not degraded even when they are held at high temperature or high humidity.

In order to improve the durability of polarizers, for example, there is proposed a method that includes subjecting a polyvinyl alcohol-based film to dyeing process, fixing process, stretching process, and so on, and then subjecting the film to a cleaning process in which the film is immersed in an aqueous solution of a polyfunctional compound of dicarboxylic acid, dicarboxylic acid chloride, diketone, or dialdehyde so that the hydroxyl groups of the polyvinyl alcohol can be partially crosslinked (JP-A No. 2006-139166). This method can improve the durability up to a point but has a problem in which the resulting polarizer also undergoes red discoloration at high temperature so that the parallel transmittance can be significantly reduced at a wavelength of about 380 to about 580 nm (particularly at neighborhood of a wavelength of 480 nm).

### SUMMARY OF THE INVENTION

An object of the present invention is to provide a polarizer that can suppress degradation in optical properties to a minimum even at high temperature, and to provide a method for producing such a polarizer.

It is another object of the present invention to provide a polarizing plate using the polarizer, and to provide an optical film in which the polarizer or the polarizing plate is laminated and to provide an image display, such as a liquid crystal display, using such a polarizing plate or such an optical film.

As a result of investigations for solving the problems, the inventors have found that the objects can be achieved with the polarizer and a method for production thereof below, so that the present invention has been completed.

The present invention relates to a polarizer including a stretched film that is obtained from a film by subjecting the film to at least a dyeing treatment with a dichroic material and a stretching treatment, wherein the film is made from a mixture containing a polyvinyl alcohol-based resin and a polycarboxylic acid compound having two or more carboxyl groups and/or one or more acid anhydride groups and a molecular weight of 1,000 or less.

In the polarizer, as the polycarboxylic acid compound, it can be used at least one selected from a group consisting of maleic acid, succinic acid, phthalic acid, maleic anhydride, succinic anhydride, citric acid, butanetetracarboxylic acid, and butanetetracarboxylic anhydride.

In the polarizer, the mixture preferably contains 0.1 to 10 parts by mole of the polycarboxylic acid compound, based on 100 parts by mole of all monomer units of the polyvinyl alcohol-based resin.

In the polarizer, an index (A) of the content of the carboxyl group in the polarizer is preferably from 0.01 to 2.5, where the index (A) is expressed by the general formula: index (A)={(intensity at 1715 cm⁻¹−intensity at 1800 cm⁻¹)/(intensity at 2940 cm⁻¹−intensity at 1800 cm⁻)}/(the carboxylic acid valence of the polycarboxylic acid compound), wherein the intensities are absorption intensities measured by FT-IR. The index (A) is more preferably from 0.05 to 1.5, further more preferably from 0.1 to 1. The index (A) is measured according to the description of Example.

In the polarizer, the mixture preferably contains 0.5 to 30 parts by weight of the polycarboxylic acid compound, based on 100 parts by weight of the polyvinyl alcohol-based resin.

The present invention also related to a method for producing the polarizer, including the processes of:

producing a film from a mixture containing a polyvinyl alcohol-based resin and a polycarboxylic acid compound having two or more carboxyl groups and/or one or more acid anhydride groups and a molecular weight of 1,000 or less; and

subjecting the film to at least a dyeing treatment process with a dichroic material and a stretching treatment process.

The present invention also related to polarizing plate, including: the above polarizer; a transparent protective film placed on at least one side of the polarizer; and an adhesive layer interposed between the polarizer and the transparent protective film.

The present invention also related to an optical film in which at least one layer of the above polarizer or the above polarizing plate is laminated.

The present invention also related to an image display, comprising the above polarizer, the above polarizing plate or the optical film.

The stretched film used for the polarizer of the present invention contains a stretched film that is obtained from a film by subjecting the film to at least a dyeing treatment with a dichroic material and a stretching treatment, and the film is made from a mixture containing a polyvinyl alcohol-based resin and a polycarboxylic acid compound having two or more carboxyl groups and/or one or more acid anhydride groups and a molecular weight of 1,000 or less (hereinafter, such a polycarboxylic acid compound-containing film may also be referred to as “polyvinyl alcohol-based film”). The polyvinyl alcohol-based film contains the polycarboxylic acid compound in addition to the polyvinyl alcohol-based resin. The polycarboxylic acid compound allows the polyvinyl alcohol-based resin to have an intermolecular crosslinked structure so that heat-induced disturbances of molecular chain orientation can be reduced, which makes it possible to improve the durability of the polarizer. In addition, the polyvinyl alcohol-based film can be crosslinked before various treatment processes, and therefore, red discoloration can also be prevented, while the durability is improved.

The polarizer of the present invention is produced by subjecting a film containing a polyvinyl alcohol-based resin and a polycarboxylic acid compound to at least a dyeing treatment process with a dichroic material and a stretching treatment process. As described above, the polyvinyl alcohol-based film contains the polycarboxylic acid compound. Therefore, a carboxyl group derived from the polycarboxylic acid compound and/or a carboxyl group derived from the acid anhydride can be introduced into the polyvinyl alcohol-based film. The polycarboxylic acid compound and the polyvinyl alcohol-based resin exist independently from each other in a mixture solution prepared by mixing them. In the process of preparing the polyvinyl alcohol-based film, however, the carboxyl group derived from the polycarboxylic acid compound is allowed to react with the hydroxyl group of the polyvinyl alcohol-based resin so that a crosslinked structure can be introduced into the polyvinyl alcohol-based resin, which allows the resulting film to have increased insolubility in water (hot water). In conclusion, it is considered that the polarizer produced with the film can have improved durability as described above, so that degradation in the optical properties can be kept to a minimum even at high temperature and that red discoloration can be prevented at high temperature.

### DETAILED DESCRIPTION OF THE PREFERRED EMBODIMENTS

The polarizer of the present invention includes a stretched film that is obtained from a film by subjecting the film to at least a dyeing treatment with a dichroic material (such as iodine or a dichroic dye) and a stretching treatment, wherein the film is made from a mixture containing a polyvinyl alcohol-based resin and a polycarboxylic acid compound having two or more carboxyl groups and/or one or more acid anhydride groups and a molecular weight of 1,000 or less.

Polyvinyl alcohol-based resin used as a material for the above film includes polyvinyl alcohol and derivatives thereof. Examples of the polyvinyl alcohol derivatives include polyvinyl formal, polyvinyl acetal and the like, and modifications of polyvinyl alcohol with an olefin such as ethylene or propylene, an unsaturated carboxylic acid such as acrylic acid, methacrylic acid or crotonic acid, or an alkyl ester thereof, acrylamide, or the like. The polyvinyl alcohol-based resin constituting the polyvinyl alcohol-based film preferably has a degree of polymerization of about 1000 to about 10000, preferably of 1000 to 5000, more preferably of 1400 to 4000. If its polymerization degree is too low, it can tend to be broken in the process of stretching at a certain ratio. If its degree of polymerization is too high, unusual tension can be required for the stretching treatment process, and thus mechanical stretching of it can be impossible. The saponification degree of the polyvinyl alcohol-based resin to be used is generally from about 80 to 100% by mole. The degree of polymerization of the polyvinyl alcohol-based resin may be measured by viscometry.

The polycarboxylic acid compound used with the polyvinyl alcohol-based resin to produce the film is a low-molecular-weight compound having two or more carboxyl groups and/or one or more acid anhydride groups and having a molecular weight of 1,000 or less.

In view of compatibility, the polycarboxylic acid compound having two carboxyl groups is preferably an aliphatic polycarboxylic acid compound, examples of which include aliphatic dicarboxylic acids such as maleic acid, phthalic acid, malonic acid, dimethylmalonic acid, succinic acid, 3,3-diethylsuccinic acid, itaconic acid, glutaric acid, 2,2-dimethylglutaric acid, adipic acid, 2-methyladipic acid, trimethyladipic acid, pimelic acid, azelaic acid, dimeracid, sebacic acid, suberic acid, and dodecadicarboxylic acid. Examples of the polycarboxylic acid compound having one or more acid anhydride groups include anhydrides of the above aliphatic dicarboxylic acids, such as maleic anhydride and succinic anhydride. Other examples of the polycarboxylic acid compound include citric acid, ethanetricarboxylic acid, propanetricarboxylic acid, butanetricarboxylic acid, butanetetracarboxylic acid, and aromatic polycarboxylic acids such as trimellitic acid, mellophanic acid, trimesic acid, prehnitic acid, hemimellitic acid, pyromellitic acid, and mellitic acid, and hydrides thereof. In an embodiment of the present invention, oligomers of the above polycarboxylic acid compounds may also be used as the polycarboxylic acid compounds. One or more of these low-molecular-weight polycarboxylic acid compounds may be used alone or in combination.

In view of compatibility, the molecular weight of the polycarboxylic acid compound is preferably 500 or less, more preferably 300 or less. Such a low-molecular-weight polycarboxylic acid compound is preferably maleic acid, succinic acid, phthalic acid, maleic anhydride, succinic anhydride, citric acid, butanetetracarboxylic acid, or butanetetracarboxylic acid anhydride.

Concerning the content ratio between the polyvinyl alcohol-based resin and the polycarboxylic acid compound, the polycarboxylic acid compound is preferably from 0.5 to 30 parts by weight, based on 100 parts by weight of the polyvinyl alcohol-based resin. When the content of the polycarboxylic acid compound is too high, the content of the polyvinyl alcohol-based resin in the film can be too low so that it can be difficult to stretch the film, which is undesirable for the production of the polarizer. On the other hand, when the content of the polycarboxylic acid compound is too low, it may be difficult to produce the effect of the addition of the polycarboxylic acid compound. Based on 100 parts by weight of the polyvinyl alcohol-based resin, the amount of the polycarboxylic acid compound is preferably from 1 to 30 parts by weight, more preferably from 2 to 20 parts by weight, even more preferably from 5 to 20 parts by weight.

Based in 100 parts by mole of all the monomer units of the polyvinyl alcohol-based resin, the low-molecular-weight polycarboxylic acid compound is preferably used in an amount of 0.1 to 10 parts by mole, more preferably 0.1 to 8 parts by mole, even more preferably 0.3 to 6 parts by mole.

The film formed from the polyvinyl alcohol-based resin may contain an additive such as a plasticizer, in addition to the polycarboxylic acid compound. Examples of the plasticizer include polyols and condensates thereof, such as glycerin, diglycerin, triglycerin, ethylene glycol, propylene glycol, and polyethylene glycol. The used amount of the plasticizer in the polyvinyl alcohol-based film is preferably, but not limited to, 20% by weight or less.

In the process of preparing the polarizer of the present invention, for example, a solution of the polyvinyl alcohol-based resin in water or an organic solvent and a solution of the polycarboxylic acid compound in water or an organic solvent may be each independently prepared and then mixed, or the polyvinyl alcohol-based resin, the polycarboxylic acid compound, and water or an organic solvent may be mixed together to form a mixed solution, and a polyvinyl alcohol-based film may be produced from the mixture by any appropriate method. In the preparation of the solution, the pH may be controlled using an alkali such as sodium hydroxide, as needed. The mixed solution is generally prepared as a 1 to 20% by weight solution. For example, the film may be formed by a flow expanding or casting method that includes casting the mixed solution and forming the solution into a film or by an extrusion method. After the forming process, the film may be heat-treated at 60 to 140° C., preferably at 100 to 120° C., for 5 to 60 minutes, preferably for 5 to 20 minutes. For example, the polyvinyl alcohol-based film may be formed on a supporting substrate (the product including the supporting substrate and the polyvinyl alcohol-based film formed thereon may be referred to as “laminated film”). The thickness of the polyvinyl alcohol-based film formed on the supporting substrate is generally from 3 to 100 μm. The polyvinyl alcohol-based film is subjected to a dyeing treatment process, a stretching treatment process, and so on, as described later. In each process, the polyvinyl alcohol-based film may be peeled off from the supporting substrate and used as an independent film, or the laminated film itself may be used. The thickness of the polyvinyl alcohol-based film may be appropriately designed depending on whether the polyvinyl alcohol-based film is used as an independent film or in the laminated film in the dyeing treatment process, the stretching treatment process, and soon. When it is used as an independent film, the film thickness is preferably from 10 to 100 μm, in order to ensure the self-supporting. On the other hand, when the laminated film is used, the film thickness may be reduced to 3 to 30 μm since the thickness of the film can be made thinner. The thickness of the polyvinyl alcohol-based film may be appropriately controlled depending on the thickness of the polarizer. The thickness of the polarizer is generally from about 1 to about 80 μm, while it may be appropriately set depending on LCD or the intended use. The thickness of the polarizer produced from the independent film is preferably from 5 to 80 μm. The thickness of the polarizer produced from the laminated film is preferably from about 1 to about 30 μm.

Examples of the material used to form the supporting substrate may include those used to form the transparent protective film described later. The thickness of the supporting substrate (before stretching treatment) is generally from about 10 to 500 μm, particularly preferably from 10 to 300 μm, more preferably from 20 to 200 μm, in view of strength or workability such as handleability and thin layer forming ability, while it may be determined as needed.

For example, the laminated film may be formed by co-extrusion of the supporting substrate-forming material and the polyvinyl alcohol-based film-forming material. The supporting substrate is integrated with the polyvinyl alcohol-based film in the laminated film produced by the co-extrusion. In the co-extrusion process, the supporting substrate-forming material and the polyvinyl alcohol-based film-forming material to form the respective layers may be supplied to a co-extruder, and thicknesses of the co-extruded supporting substrate and polyvinyl alcohol-based film may be each preferably controlled to be in the above range.

The polarizer according to the present invention is produced by subjecting the polyvinyl alcohol-based film to a dyeing treatment with a dichroic substance and a stretching treatment.

The dyeing treatment process is typically performed by immersing the polyvinyl alcohol-based film in a treatment bath containing a dichroic material such as iodine. Water is generally used as a solvent for the dyeing bath solution, to which a proper amount of an organic solvent compatible with water may be added. The content of the dichroic material in the dyeing bath solution may be appropriately selected depending on the stretching treatment process. In the case of a wet stretching treatment, the dichroic material is generally used in an amount of 0.1 to 1 part by weight, based on 100 parts by weight of the solvent. In the case of a dry stretching treatment, the dichroic material is generally used in an amount of 0.5 to 5 parts by weight, based on the 100 parts by weight of the solvent, because the crystallinity of the polyvinyl alcohol-based film may be increased by the heat so that the dye-affinity may tend to be reduced. When iodine is used as the dichroic material, the dyeing bath solution preferably contain an aid such as an iodide, so that the dyeing efficiency can be improved. The aid is preferably used in an amount of 0.02 to 20 parts by weight, more preferably of 2 to 10 parts by weight, based on 100 parts by weight of the solvent. Examples of the iodide include potassium iodide, lithium iodide, sodium iodide, zinc iodide, aluminum iodide, lead iodide, copper iodide, barium iodide, calcium iodide, tin iodide, and titanium iodide. The temperature of the dyeing bath is generally from about 20 to about 70° C., and the time of immersion in the dyeing bath is generally from about 1 to about 20 minutes. In the dyeing treatment process, the polyvinyl alcohol-based film may be used as an independent film or in the laminated film, as described above. When the polyvinyl alcohol-based film is relatively thin, however, the dyeing treatment process is preferably performed on the laminated film.

The stretching treatment process may be performed at any stage. Specifically, the stretching treatment process maybe performed before or after the dyeing treatment, performed simultaneously with a swelling treatment, the dyeing treatment, or a crosslinking treatment, or performed after the crosslinking treatment. The polyvinyl alcohol-based film is generally stretched to a total stretched ratio of 4 or more, preferably 5 or more, more preferably 5 to 7, even more preferably 5 to 6.5. When the total stretch ratio is less than 4, it may be difficult to produce a polarizing plate with high degree of polarization. When the total stretch ratio is more than 7, the polyvinyl alcohol-based film may be more likely to rupture.

The stretching treatment is generally performed by uniaxial stretching. The uniaxial stretching may be any of longitudinal stretching performed in the longitudinal direction of the polyvinyl alcohol-based film and transverse stretching performed in the width direction of the laminate. In the transverse stretching, the film may be shrunken in the longitudinal direction, while it is stretched in the width direction. Examples of transverse stretching include fixed-end uniaxial stretching method with one end fixed through a tenter and free-end uniaxial stretching method with no end fixed. Examples of longitudinal stretching method include stretching method between rolls, compression stretching method, and stretching method with a tenter. The stretching treatment may be a multistage treatment. The stretching treatment may also be performed by biaxial stretching method or oblique stretching method. Specifically, any of a wet stretching method and a dry stretching method may be used, and any appropriate method may be used. For example, when a wet stretching method is used, the polyvinyl alcohol-based film may be stretched to a desired ratio in a treatment bath. A solution prepared by adding a material to meet each treatment requirement, such as iodine, boron, or a metal salt such as a zinc salt, to a solvent such as water or an organic solvent (for example, ethanol) is preferably used for the stretching bath. On the other hand, examples of the dry stretching method include stretching method between rolls, heating roll stretching method, compression stretching method, and tenter stretching method. In the stretching means, the unstretched film is generally heated. The polarizer of the present invention has improved durability, even when it is a thin polyvinyl alcohol-based film. Therefore, the dry stretching method is also preferably used.

In the stretching treatment process, the polyvinyl alcohol-based film may be used as an independent film or in the laminated film, as described above. When the polyvinyl alcohol-based film is relatively thin, however, the stretching treatment process is preferably performed on the laminated film. When the laminated film is stretched, the supporting substrate is also stretched together with the polyvinyl alcohol-based film.

Besides the stretching treatment and the dyeing treatment, various treatments may be performed in producing the polarizer of the present invention. In a producing method of polarizer, when a wet stretching method is adopted as the stretching treatment, for example, a method that may be used includes subjecting the polyvinyl alcohol-based film to a series of producing processes generally including swelling, dyeing, crosslinking, stretching(wet), washing with water, and drying. In a producing method of a polarizer of the present invention, the above processes were applied Except for the drying process, each process may be performed while the polyvinyl alcohol-based film is immersed in a bath containing a solution necessary for each process. Concerning the processes of swelling, dyeing, crosslinking, stretching (wet), washing with water, and drying, the order of the processes, the number of times of each process, or the presence or absence of each processes may be appropriately determined depending on the purpose, the materials to be used and the conditions. For example, some treatments may be simultaneously performed in a single process, and swelling treatment, dyeing treatment and crosslinking treatment may be performed at the same time. For example, crosslinking treatment before or after stretching treatment is preferably employed. For example, washing treatment with water may be performed after all of the other treatment or only after a certain treatment. On the other hand, in a producing method of polarizer, when a dry stretching method is adopted as the stretching treatment, for example, a method that may be used includes subjecting the polyvinyl alcohol-based film to a series of producing processes generally including stretching (wet), dyeing, crosslinking, washing with water, and drying.

The swelling treatment process is typically performed by immersing the polyvinyl alcohol-based film in a treatment bath containing water. By this treatment, the surface of the polyvinyl alcohol-based film is cleaned of dirt and an anti-blocking agent, and the polyvinyl alcohol-based film is allowed to swell so that unevenness such as uneven dyeing can be prevented. Glycerin, potassiumiodide and so on may be added, as appropriate, to the swelling bath. The temperature of the swelling bath is generally from about 20 to about 60° C., and the time of immersion in the swelling bath is generally from about 0.1 to about 10 minutes.

The crosslinking treatment process is typically performed by immersing the dyed polyvinyl alcohol-based film in a treatment bath containing a crosslinking agent. Any appropriate crosslinking agent may be used. Examples of the crosslinking agent include boron compounds such as boric acid and borax, glyoxal, and glutaraldehyde. One or more of these crosslinking agents may be used alone or in combination. Water is generally used as a solvent for the crosslinking bath solution, to which a proper amount of an organic solvent compatible with water may be added. The crosslinking agent is generally used in an amount of 1 to 10 parts by weight, based on 100 parts by weight of the solvent. If the content of the crosslinking agent is less than 1 part by weight, the resulting optical properties can be insufficient. If the content of the crosslinking agent is more than 10 parts by weight, large stress can be applied to the film during stretching so that the resulting polarizing plate could be shrunk. The crosslinking bath solution preferably contains an aid such as an iodide, so that uniform in-plane properties can be easily obtained. The concentration of the aid is preferably from 0.05 to 15% by weight, more preferably from 0.5 to 8% by weight. Examples of the iodide may be the same as in the case of the dyeing treatment process. The temperature of the crosslinking bath is generally from about 20 to about 70° C., preferably from 40 to 60° C. The time of immersion in the crosslinking bath is generally from about 1 second to about 15 minutes, preferably from 5 seconds to 10 minutes.

Besides the treatments described above, metal ion treatment may also be performed. The metal ion treatment may be performed by immersing the laminate in an aqueous solution containing a metal salt. The metal ion treatment makes it possible to impregnate the hydrophilic polymer layer of the laminate with various metal ions.

Particularly in order to control the color tone or to impart durability, ions of transition metal such as cobalt, nickel, zinc, chromium, aluminum, copper, manganese, or iron are preferably used. In order to control the color tone or to impart durability, zinc ions are particularly preferred. Examples of zinc salts include zinc halides such as zinc chloride and zinc iodide, and zinc sulfate and zinc acetate.

The metal ion impregnation treatment may use a metal salt solution. The concentration of zinc ions in the metal salt solution may be from about 0.1 to about 10% by weight, preferably from 0.3 to 7% by weight. An aqueous metal salt solution containing an iodide such as potassium iodide is preferably used, because it can facilitate the metal ion to impregnate. The concentration of the iodide in the metal salt solution is preferably from about 0.1 to about 10% by weight, more preferably from 0.2 to 5% by weight.

In the metal ion impregnation treatment, the temperature of the metal salt solution is generally from about 15 to about 85° C., preferably from 25 to 70° C., and the immersion time is generally from about 1 to about 120 seconds, preferably from 3 to 90 seconds. The metal ion impregnation treatment may be performed at any stage. A zinc salt may coexist in the dyeing solution and/or the crosslinking solution, and the metal ion impregnation treatment may be performed simultaneously with the dyeing treatment and/or the crosslinking treatment. The metal ion impregnation treatment may also be performed simultaneously with the stretching treatment.

The process of washing with water is typically performed by immersing the polyvinyl alcohol-based film on which the above-described various treatments are carried out in a treatment bath. Unnecessary residues can be washed away from the polyvinyl alcohol-based film by the process of washing with water. The water-washing bath may be of pure water or an aqueous solution of an iodide such as potassium iodide and sodium iodide. The aqueous iodide solution preferably has a concentration of 0.1 to 10% by weight. An aid such as zinc sulfate and zinc chloride may be added to the aqueous iodide solution. The temperature of the water-washing bath is preferably from 10 to 60° C., more preferably from 30 to 40° C. The immersion time may be from 1 second to 1 minute. The process of washing with water may be performed only once or twice or more, if necessary. When the process of washing with water is performed twice or more, the type and concentration of the additive contained in the water-washing bath for each treatment may be controlled as appropriate. For example, the process of washing with water may include immersing the polyvinyl alcohol-based film in an aqueous potassium iodide solution (0.1 to 10% by weight, 10 to 60° C.) for 1 second to 1 minute after any of the above treatments and rinsing the film with pure water. In the process of washing with water, an organic solvent compatible with water (such as ethanol) may be added as appropriate in order to modify the surface of the polarizer or increase the efficiency of drying of the polarizer.

Any appropriate methods such as natural drying, blow drying, and drying by heating may be used in the drying process. In the case of drying by heating, for example, the drying temperature is generally from about 20 to about 80° C., and the drying time is generally from about 1 to about 10 minutes. The polarizer may be obtained as described above.

The polarizing plate according to the present invention generally includes the polarizer of the present invention and a transparent protective film provided on one or both sides of the polarizer with an adhesive layer interposed therebetween. When the polarizer is produced by subjecting the laminated film to each treatment process, the supporting substrate of the laminated film may be used as a transparent protective film in the resulting polarizer. In this mode, a material capable of keeping its retardation low even after the stretching treatment process is preferably used for the supporting substrate. In this case, a transparent protective film may be bonded to the other side of the polarizer than the supporting substrate side. Alternatively, the polarizer may be peeled off from the supporting substrate, and then, a transparent protective film may be bonded to one or both sides of the polarizer. When the polarizer is produced by subjecting the laminated film to each treatment process, a transparent protective film may be bonded to the resulting polarizer, and then, the supporting substrate of the laminated film may be peeled off.

A thermoplastic resin with a high level of transparency, mechanical strength, thermal stability, moisture blocking properties, isotropy, and the like may be used as a material for forming the transparent protective film. Examples of such a thermoplastic resin include cellulose resins such as triacetylcellulose, polyester resins, polyethersulfone resins, polysulfone resins, polycarbonate resins, polyamide resins, polyimide resins, polyolefin resins, (meth)acrylic resins, cyclic olefin polymer resins (norbornene resins), polyarylate resins, polystyrene resins, polyvinyl alcohol-based resins, and any mixture thereof. The transparent protective film is generally laminated to one side of the polarizer with the adhesive layer, but thermosetting resins or ultraviolet curing resins such as (meth)acrylic, urethane, acrylic urethane, epoxy, or silicone resins maybe used to other side of the polarizer for the transparent protective film. The transparent protective film may also contain at least one type of any appropriate additive. Examples of the additive include an ultraviolet absorbing agent, an antioxidant, a lubricant, a plasticizer, a release agent, an anti-discoloration agent, a flame retardant, a nucleating agent, an antistatic agent, a pigment, and a colorant. The content of the thermoplastic resin in the transparent protective film is preferably from 50 to 100% by weight, more preferably from 50 to 99% by weight, still more preferably from 60 to 98% by weight, particularly preferably from 70 to 97% by weight. If the content of the thermoplastic resin in the transparent protective film is 50% by weight or less, high transparency and other properties inherent in the thermoplastic resin can fail to be sufficiently exhibited.

Thickness of the transparent protective film can be properly determined and generally from about 1 to about 500 μm from the viewpoint of a strength, workability such as handlability, requirement for a thin film and the like. Especially, the thickness of the transparent protective film is preferably from 1 to 300 μm and more preferably in the range of from 1 to 200 μm. The thickness of the transparent protective film is further preferably in the range of from 1 to 90 μm and more preferably in the range of from 1 to 50 μm.

In a case where the transparent protective films are provided on both sides of a polarizer, the protective films made from the same polymer may be used on both sides thereof or alternatively, the protective films made from polymer materials different from each other may also be used on respective both sides thereof.

At least one selected from a cellulose resin, a polycarbonate resin, a cyclic polyolefin resin, and a (meth)acrylic resin is preferably used for the transparent protective film according to the present invention.

Examples of the retardation plate include a birefringent film produced by uniaxially or biaxially stretching a polymer material, an oriented liquid crystal polymer film, and an oriented liquid crystal polymer layer supported on a film. The thickness of the retardation plate is generally, but not limited to, from about 20 to about 150 μm.

Examples of the polymer material include polyvinyl alcohol, polyvinyl butyral, poly(methyl vinyl ether), poly(hydroxyethyl acrylate), hydroxyethyl cellulose, hydroxypropyl cellulose, methylcellulose, polycarbonate, polyarylate, polysulfone, polyethylene terephthalate, polyethylene naphthalate, polyethersulfone, polyphenylene sulfide, polyphenylene oxide, polyallylsulfone, polyamide, polyimide, polyolefin, polyvinyl chloride, cellulose resins, cyclic polyolefin resins (norbornene reins), and various types of binary or ternary copolymers thereof, graft copolymers thereof, and any blend thereof. Any of these polymer materials may be formed into an oriented product (a stretched film) by stretching or the like.

The retardation plate may have any appropriate retardation depending on the intended use such as compensation for coloration, viewing angle, or the like due to the birefringence of various wave plates or liquid crystal layers. Two or more types of retardation plates may also be laminated to provide controlled optical properties, including retardation.

A retardation plate satisfying the relation: nx=ny>nz, nx>ny>nz, nx>ny=nz, nx>nz>ny, nz=nx>ny, nz>nx>ny, or nz>nx=ny may be selected and used depending on various applications. The relation ny=nz includes not only the case where ny is completely equal to nz but also the case where ny is substantially equal to nz.

The film with retardation may be separately prepared and laminated to a transparent protective film with no retardation so that the function described above can be provided.

The transparent protective film may be subjected to surface modification treatment before it is applied with the adhesive. Specific examples of such treatment include corona treatment, plasma treatment, flame treatment, primer treatment, glow treatment, saponification treatment, and coupling agent treatment. The transparent protective film may have an antistatic layer.

A hard coat layer may be prepared, or antireflection processing, processing aiming at sticking prevention, diffusion or anti glare may be performed onto the face of the transparent protective film on which the polarizing film not been adhered.

An adhesive may be used to bond the polarizer to the transparent protective film. Examples of the adhesive include isocyanate adhesives, polyvinyl alcohol adhesives, gelatin adhesives, vinyl adhesives, latex adhesives, and aqueous polyester adhesives. The adhesive is generally used in the form of an aqueous solution generally having a solids content of 0.5 to 60% by weight. Besides the above adhesives, ultraviolet-curable adhesives, electron beam-curable adhesives or the like may also be used. Electron beam-curable adhesives exhibit good adhesion to the various types of transparent protective films. Adhesives that may be used in an embodiment of the present invention may also contain a metal compound filler.

A polarizing plate of the present invention may be used in practical use as an optical film laminated with other optical layers. Although there is especially no limitation about the optical layers, one layer or two layers or more of optical layers, which may be used for formation of a liquid crystal display etc., such as a reflector, a transflective plate, a retardation plate (a half wavelength plate and a quarter wavelength plate included), and a viewing angle compensation film, may be used. Especially preferable polarizing plates are; a reflection type polarizing plate or a transflective type polarizing plate in which a reflector or a transflective reflector is further laminated onto a polarizing plate of the present invention; an elliptically polarizing plate or a circular polarizing plate in which a retardation plate is further laminated onto the polarizing plate; a wide viewing angle polarizing plate in which a viewing angle compensation film is further laminated onto the polarizing plate; or a polarizing plate in which a brightness enhancement film is further laminated onto the polarizing plate.

In the polarizing plate mentioned above and the optical film in which at least one layer of the polarizing plate is laminated, a pressure-sensitive adhesive layer may also be prepared for adhesion with other members, such as a liquid crystal cell etc. As pressure-sensitive adhesive that forms pressure-sensitive layer is not especially limited, and, for example, acrylic type polymers; silicone type polymers; polyesters, polyurethanes, polyamides, polyethers; fluorine type and rubber type polymers may be suitably selected as a base polymer. Especially, a pressure-sensitive adhesive such as acrylics type pressure-sensitive adhesives may be preferably used, which is excellent in optical transparency, showing adhesion characteristics with moderate wettability, cohesiveness and adhesive property and has outstanding weather resistance, heat resistance, etc.

Moreover, a pressure-sensitive adhesive layer with low moisture absorption and excellent heat resistance is desirable. This is because those characteristics are required in order to prevent foaming and peeling-off phenomena by moisture absorption, in order to prevent decrease in optical characteristics and curvature of a liquid crystal cell caused by thermal expansion difference etc. and in order to manufacture a liquid crystal display excellent in durability with high quality.

The pressure-sensitive adhesive layer may contain additives, for example, such as natural or synthetic resins, adhesive resins, glass fibers, glass beads, metal powder, fillers comprising other inorganic powder etc., pigments, colorants and antioxidants. Moreover, it may be a pressure-sensitive adhesive layer that contains fine particle and shows optical diffusion nature.

A polarizing plate or an optical film of the present invention may be preferably used for manufacturing various equipment, such as liquid crystal display, etc. Assembling of a liquid crystal display may be carried out according to conventional methods. That is, a liquid crystal display is generally manufactured by suitably assembling several parts such as a liquid crystal cell, polarizing plates or optical films and, if necessity, lighting system, and by incorporating driving circuit. In the present invention, except that a polarizing plate or an optical film by the present invention is used, there is especially no limitation to use any conventional methods. Also any liquid crystal cell of arbitrary type, such as TN type, and STN type, π type, VA type, IPS type may be used.

Suitable liquid crystal displays, such as liquid crystal display with which the above-mentioned polarizing plate or optical film has been located at one side or both sides of the liquid crystal cell, and with which a backlight or a reflector is used for a lighting system may be manufactured. In this case, the polarizing plate or optical film by the present invention may be installed in one side or both sides of the liquid crystal cell. When installing the polarizing plate or optical films in both sides, they may be of the same type or of different type. Furthermore, in assembling a liquid crystal display, suitable parts, such as diffusion plate, anti-glare layer, antireflection film, protective plate, prism array, lens array sheet, optical diffusion plate, and backlight, may be installed in suitable position in one layer or two or more layers.

### EXAMPLES

Examples of the present invention are described below, which are not intended to limit the embodiments of the present invention.

### Example 1

### (Polyvinyl Alcohol-Based Resin)

A polyvinyl alcohol with an average degree of polymerization of 2,400 and a degree of saponification of 99.9% by mole (JC25 (trade name) manufactured by Japan Vam & Poval Co., Ltd.) was stirred in hot water at 95° C. for 2 hours to form an aqueous 12% by weight polyvinyl alcohol solution. Based on 100 parts by weight of the polyvinyl alcohol, 10 parts by weight of glycerin was added to the aqueous polyvinyl alcohol solution.

### (Polycarboxylic Acid Compound)

Maleic acid was stirred in hot water at 80° C. to form an aqueous 9% by weight maleic acid solution.

### (Mixture Solution)

The aqueous polyvinyl alcohol solution and the aqueous maleic acid solution were mixed in a weight ratio of the solid of the former to the solid of the latter of 100:10 and then stirred at 80° C. for 5 minutes to form a mixture solution. Based on 100 parts by mole of all the monomer units of the polyvinyl alcohol, the amount of the maleic acid was 3.8 parts by mole.

### (Polyvinyl Alcohol-Based Film)

The mixture solution was cast on a 75 μm-thick polyester film and allowed to stand at room temperature (23° C.) for 24 hours so that a polyvinyl alcohol-based film with a thickness of 65 μm±10 μm was obtained. The film was then held in an oven at 140° C. for 10 minutes to be heat-treated. The polyvinyl alcohol-based film was peeled off from the polyester film and used as an independent film.

### (Polarizer)

The resulting polyvinyl alcohol-based film was immersed in water at 30° C. so that it was allowed to swell, and it was also uniaxially stretched in water (to a stretch ratio of 3.5). The film was then dyed in a 0.3% by weight iodine solution (with a weight ratio of iodine/potassium iodide of 0.5/8) at 30° C. for 60 seconds. Subsequently, the film was immersed in a first aqueous boric acid solution (with a boric acid concentration of 3% by weight and a potassium iodide concentration of 3% by weight) at 30° C. for 45 seconds and then stretched to a total stretch ratio of 6, while it was immersed in a second aqueous boric acid solution (with a boric acid concentration of 4% by weight and a potassium iodide concentration of 5% by weight) at 60° C. The film was then immersed in an aqueous potassium iodide solution (with a potassium iodide concentration of 4% by weight) at 30° C. for 10 seconds. After the stretching, the film was dried in an oven at 60° C. for 3 minutes so that a polarizer with a thickness of 26 μm±5 μm was obtained.

### Example 2

A polarizer was produced using the process of Example 1, except that citric acid was used as the polycarboxylic acid compound to form an aqueous 9% by weight citric acid solution, the aqueous polyvinyl alcohol solution and the aqueous citric acid solution were mixed in a weight ratio of the solid of the former to the solid of the latter of 100:10 in the preparation of the mixture solution, and the temperature of the heat treatment in the preparation of the polyvinyl alcohol-based film was changed to 160° C. Based on 100 parts by mole of all the monomer units of the polyvinyl alcohol, the amount of the citric acid was 2.3 parts by mole.

### Example 3

A polarizer was produced using the process of Example 1, except that butanetetracarboxylic acid was used as the polycarboxylic acid compound to form an aqueous 9% by weight butanetetracarboxylic acid solution, the aqueous polyvinyl alcohol solution and the aqueous butanetetracarboxylic acid solution were mixed in a weight ratio of the solid of the former to the solid of the latter of 100:10 in the preparation of the mixture solution, and the temperature of the heat treatment in the preparation of the polyvinyl alcohol-based film was changed to 160° C. Based on 100 parts by mole of all the monomer units of the polyvinyl alcohol, the amount of the butanetetracarboxylic acid was 2.3 parts by mole.

### Example 4

### (Polycarboxylic Acid Compound)

Maleic acid was stirred in hot water at 80° C. to form an aqueous 2% by weight maleic acid solution.

### (Mixture Solution)

The aqueous polyvinyl alcohol solution prepared in Example 1 and the aqueous maleic acid solution were mixed in a weight ratio of the solid of the former to the solid of the latter of 100:10 and then stirred at 80° C. for 5 minutes to form a mixture solution. Based on 100 parts by mole of all the monomer units of the polyvinyl alcohol, the amount of the maleic acid was 0.8 parts by mole.

### (Polyvinyl Alcohol-Based Film)

The mixture solution was cast on a 100 μm-thick transparent film (Arton manufactured by JSR Corporation) and then held in an oven at 80° C. for 5 minutes so that a polyvinyl alcohol-based film with a thickness of 7 μm±2 μm was obtained (in the laminated film).

### (Polarizer)

The resulting polyvinyl alcohol-based film (the laminated film) was uniaxially stretched to 5.0 times in the atmosphere at 150° C. The stretched film was then immersed in a dyeing bath (with an iodine concentration of 1% by weight) at 30° C. for 60 seconds so that it was dyed. Subsequently, the film was immersed in an aqueous boric acid solution (with a boric acid concentration of 5% by weight and a potassium iodide concentration of 5% by weight) at 30° C. for 60 seconds and then dried in an oven at 60° C. for 3 minutes so that a polarizer with a thickness of 2 μm±1 μm was obtained.

### Comparative Example 1

A polarizer was produced using the process of Example 1, except that no polycarboxylic acid compound was used, namely, the polyvinyl alcohol-based film was produced using the aqueous polyvinyl alcohol solution in place of the mixture solution.

### Comparative Example 2

### (Polyvinyl Alcohol-Based Film)

A polyvinyl alcohol-based film was prepared using the process of Example 1, except that no polycarboxylic acid compound was used, namely, the polyvinyl alcohol-based film was prepared using the aqueous polyvinyl alcohol solution in place of the mixture solution.

### (Polarizer)

The resulting polyvinyl alcohol-based film was immersed in water at 30° C. so that it was allowed to swell, and it was also uniaxially stretched in water (to a stretch ratio of 3.5). The film was then dyed in a 0.3% by weight iodine solution (with a weight ratio of iodine/potassium iodide of 0.5/8) at 30° C. for 60 seconds. Subsequently, the film was immersed in a first aqueous boric acid solution (with a boric acid concentration of 3% by weight and a potassium iodide concentration of 3% by weight) at 30° C. for 45 seconds and then stretched to a total stretch ratio of 6, while it was immersed in a second aqueous boric acid solution (with a boric acid concentration of 4% by weight and a potassium iodide concentration of 5% by weight) at 60° C. The film was then immersed in an aqueous potassium iodide solution containing 5% by weight of maleic acid (with a potassium iodide concentration of 4% by weight) at 30° C. for 10 seconds. After the stretching, the film was dried in an oven at 60° C. for 3 minutes so that a polarizer with a thickness of 26 μm±5 μm was obtained.

### Comparative Example 3

A polarizer was produced using the process of Comparative Example 2, except that citric acid was used in place of maleic acid for the aqueous potassium iodide solution.

### Comparative Example 4

A polarizer was produced using the process of Comparative Example 2, except that butanetetracarboxylic acid was used in place of maleic acid for the aqueous potassium iodide solution.

### [Evaluation]

The polarizer obtained in each of the examples and the comparative examples was evaluated as described below. The results of the evaluation are shown in Table 2. The type of the polycarboxylic acid compound used in each example and other conditions are shown in Table 1.

### <Measurement of Insolubility>

The polarizer was cut into small pieces of 3 cm×5 cm, and the weight (W1) of each piece was measured. The piece was held between SUS #25 metal meshes and held in hot water at 95° C. for 60 minutes. The remaining small piece was then dried at 120° C. for 1 hour and weighed (W2). The insolubility was calculated from the results according to the equation: Insolubility (%)=(W2/W1)×100%.

### <Heat Resistance>

An optical measurement system (V-7100 manufactured by JASCO Corporation) was used to measure the optical properties of the polarizer, and the single piece transmittance (Ts) was determined. The single piece transmittance (Ts) was measured before and after the polarizer was held in an oven at 120° C. for 1 hour, and a change in single piece transmittance (ΔTs) was calculated from the single piece transmittance values according to the equation: ΔTs=Ts2−Ts1, wherein Ts1 is the single piece transmittance before the heating, and Ts2 is the single piece transmittance after the heating.

### <Carboxyl Group Quantification>

The content of the carboxyl group in the polarizer was determined by measurement of the polarizer by FT-IR (Fourier transform infrared spectroscopy). The measurement was performed under the following conditions: measurement mode, reflection (ATR); measurement wavelength, 650-4,000 cm⁻¹; integration, 16 times. The absorption from a carbonyl group is observed at 1715 cm⁻¹, and the absorption from CH of polyvinyl alcohol is observed at 2940 cm⁻¹. Therefore, the intensity at 1715 cm⁻¹ was compared with the intensity at 2940 cm⁻¹, and a valued divided by the carboxylic acid valence of the polycarboxylic acid compound (2 for maleic acid, 3 for citric acid, 4 for butanetetracarboxylic acid) was obtained. A quantitative index (A) of the content of the carboxyl group in the polarizer was calculated according to the equation below. In this process, the baseline for the absorption intensity was at 1800 cm⁻¹ where no absorption was observed.

Index (A) of the carboxyl group content={(the intensity at 1715 cm⁻¹−the intensity at 1800 cm⁻¹)/(the intensity at 2940 cm⁻¹−the intensity at 1800 cm⁻¹)}/(the carboxylic acid valence). A calibration curve represented by formula 1 below was also obtained using standard samples of polyvinyl alcohols each having a given amount of an incorporated carboxylic acid-containing polymer. The carboxylic acid compound in the polarizer was quantified using formula 1. The calibration curve was obtained from intensities as described above by measuring several points of carboxylic acid compound concentration in the range of 0.2 to 14% by mole with respect to standard samples using maleic acid, citric acid, and butanetetracarboxylic acid as carboxylic acid compounds.

[Carboxylic acid compound concentration (% by mole)]=9.74×(A)−0.15 Formula 1:

### <Optical Properties>

The parallel transmittance (Tp) of polarizers in the parallel Nicol configuration was measured at a wavelength of 480 nm with an integrating sphere-equipped spectrophotometer (V7100 manufactured by JASCO Corporation). In the measurement of the transmittance for each linearly polarized light, the transmittance for completely polarized light obtained through a Glan-Taylor prism polarizer was normalized as 100%. These transmittances were Y values which had undergone luminosity correction in the two-degree visual field (C illuminant) according to JIS Z 8701. The parallel transmittance (Tp) was measured immediately after the production of the polarizer (initial value) and after the polarizer was stored in the atmosphere at 120° C. for 1 hour (post-treatment value). The difference (ΔTp) between the initial value and the post-treatment value of the parallel transmittance (Tp) is also shown.

TABLE 1

| | Polycarboxylic acid compound | | | | | | | | |
|---|---|---|---|---|---|---|---|---|---|
| | | | | Content | | | | | |
| | | | | (parts by | | | | | |
| | | | | mole) based | | | | | |
| | | | | on 100 parts | | | | | |
| | | | | by mole of | | Film preparation | | | |
| | | | Amount | all monomer | Aqueous bath | Heat | | | |
| | | | (parts | units of | solution | treatment | | | |
| | | Addition | by | polyvinyl | concentration | temperature | Form of film | Thickness | Stretching |
| | Type | method | weight) | alcohol | (% by weight) | (° C.) | used | (μm) | treatment |
| Example 1 | Maleic | Blending | 10 | 3.8 | — | 140 | Independent | 65 ± 10 | Wet |
| | acid | | | | | | | | |
| Example 2 | Citric | Blending | 10 | 2.3 | — | 160 | Independent | 65 ± 10 | Wet |
| | acid | | | | | | | | |
| Example 3 | BTCA | Blending | 10 | 1.9 | — | 160 | Independent | 65 ± 10 | Wet |
| Example 4 | Maleic | Blending | 2.2 | 0.8 | — | (80° C.) | Laminated | 7 ± 2 | Dry |
| | acid | | | | | | | | |
| Comparative | — | — | — | — | — | 120 | Independent | 65 ± 10 | Wet |
| Example 1 | | | | | | | | | |
| Comparative | Maleic | Addition | — | — | 5 | 120 | Independent | 65 ± 10 | Wet |
| Example 2 | acid | to bath | | | | | | | |
| Comparative | Citric | Addition | — | — | 5 | 120 | Independent | 65 ± 10 | Wet |
| Example 3 | acid | to bath | | | | | | | |
| Comparative | BTCA | Addition | — | — | 5 | 120 | Independent | 65 ± 10 | Wet |
| Example 4 | | to bath | | | | | | | |

In Table 1, BTCA represents butanetetracarboxylic acid, “blending” represents the case that the polycarboxylic acid compound was used in the preparation of the polyvinyl alcohol-based film, and “addition to bath” represents the case that the polycarboxylic acid compound was used in the aqueous potassium iodide solution when the polarizer was produced. The heat treatment temperature (80° C.) in the preparation of the film of Example 4 corresponds to the temperature maintained during the preparation of the film.

TABLE 2

| | Evaluation | | | | | | |
|---|---|---|---|---|---|---|---|
| | | Heat | Index | | Optical properties | | |
| | | resistance: | (A) of | Carboxylic | Initial | Post-treatment | |
| | | change (ΔTs) in | carboxyl | acid compound | Parallel | Parallel | ΔTp = initial |
| | Insolubility | single-piece | group | concentration | transmittance | transmittance | value-post- |
| | (%) | transmittance | content | (% by mole) | (Tp) | (Tp) | treatment value |
| Example 1 | 66 | 0.61 | 0.24 | 2.2 | 35.7 | 34.5 | 1.2 |
| Example 2 | 50 | 0.85 | 0.07 | 0.5 | 36.6 | 35.7 | 0.9 |
| Example 3 | 58 | 0.71 | 0.11 | 0.9 | 36.4 | 35.9 | 0.5 |
| Example 4 | 40 | 0.79 | 0.06 | 0.4 | 34.1 | 32.6 | 1.5 |
| Comparative | 0 | 1.18 | — | — | 36.6 | 35.3 | 1.3 |
| Example 1 | | | | | | | |
| Comparative | 0 | 19.5 | 0.18 | 1.6 | 36.1 | 1.7 | 34.4 |
| Example 2 | | | | | | | |
| Comparative | 0 | 26.5 | 0.10 | 0.9 | 35.7 | 0.3 | 35.4 |
| Example 3 | | | | | | | |
| Comparative | 0 | 9.9 | 0.13 | 1.1 | 35.4 | 8.8 | 26.6 |
| Example 4 | | | | | | | |

The examples and the comparative examples show that there is a correlation between ΔTs and the insolubility, namely the higher the insolubility, the smaller the ΔTs. The high insolubility is found to be effective for the heat resistance. For example, in order to increase the heat resistance by about 20% (ΔTs<1) as compared to Comparative Example 1 (a conventional example where no polycarboxylic acid compound is added), the insolubility should preferably be set to 15% or more. It is also apparent that an increase in the polycarboxylic acid compound content, namely an increase in the quantitative index (A) of carboxyl group, is effective in increasing the insolubility and improving the heat resistance.

It is also apparent that the reduction in parallel transmittance (Tp) at a wavelength of 480 nm is smaller in the polarizer of each example than in that of each comparative example.

What is claimed is:

1. A polarizer comprising a stretched film that is obtained from a film by subjecting the film to at least a dyeing treatment with a dichroic material and a stretching treatment, wherein the film is made from a mixture containing a polyvinyl alcohol-based resin and a polycarboxylic acid compound having two or more carboxyl groups and/or one or more acid anhydride groups and a molecular weight of 1,000 or less.

2. The polarizer according to claim 1, wherein the polycarboxylic acid compound is at least one selected from a group consisting of maleic acid, succinic acid, phthalic acid, maleic anhydride, succinic anhydride, citric acid, butanetetracarboxylic acid, and butanetetracarboxylic anhydride.

3. The polarizer according to claim 1, wherein the mixture contains 0.1 to 10 parts by mole of the polycarboxylic acid compound, based on 100 parts by mole of all monomer units of the polyvinyl alcohol-based resin.

4. The polarizer according to claim 1, wherein an index (A) of the content of the carboxyl group in the polarizer is from 0.01 to 2.5, where the index (A) is expressed by the general formula: index (A)={(intensity at 1715 cm⁻¹−intensity at 1800 cm⁻¹)/(intensity at 2940 cm⁻¹−intensity at 1800 cm⁻)}/(the carboxylic acid valence of the polycarboxylic acid compound), wherein the intensities are absorption intensities measured by FT-IR.

5. The polarizer according to claim 1, wherein the mixture contains 0.5 to 30 parts by weight of the polycarboxylic acid compound, based on 100 parts by weight of the polyvinyl alcohol-based resin.

6. A method for producing the polarizer, comprising the processes of:
producing a film from a mixture containing a polyvinyl alcohol-based resin and a polycarboxylic acid compound having two or more carboxyl groups and/or one or more acid anhydride groups and a molecular weight of 1,000 or less; and
subjecting the film to at least a dyeing treatment process with a dichroic material and a stretching treatment process.

7. The method according to claim 6, wherein the polycarboxylic acid compound is at least one selected from a group consisting of maleic acid, succinic acid, phthalic acid, maleic anhydride, succinic anhydride, citric acid, butanetetracarboxylic acid, and butanetetracarboxylic anhydride.

8. The method according to claim 6, wherein the mixture contains 0.1 to 10 parts by mole of the polycarboxylic acid compound, based on 100 parts by mole of all monomer units of the polyvinyl alcohol-based resin.

9. The method according to claim 6, wherein an index (A) of the content of the carboxyl group in the polarizer is from 0.01 to 2.5, where the index (A) is expressed by the general formula: index (A)={(intensity at 1715 cm⁻¹−intensity at 1800 cm⁻¹)/(intensity at 2940 cm⁻¹−intensity at 1800 cm⁻¹)}/(the carboxylic acid valence of the polycarboxylic acid compound), wherein the intensities are absorption intensities measured by FT-IR.

10. The method according to claim 6, wherein the mixture contains 0.5 to 30 parts by weight of the polycarboxylic acid compound, based on 100 parts by weight of the polyvinyl alcohol-based resin.

11. A polarizing plate, comprising: the polarizer according to claim 1; a transparent protective film placed on at least one side of the polarizer; and an adhesive layer interposed between the polarizer and the transparent protective film.

12. An optical film in which at least one layer of the polarizer according to claim 1 is laminated.

13. An optical film in which at least one layer of the polarizing plate according to claim 11 is laminated.

14. An image display, comprising the polarizer according to claim 1.

15. An image display, comprising the polarizing plate according to claim 11.

16. An image display, comprising the optical film according to claim 13.
